(19) United States
(12) Patent Application Publication
(10) Pub. No.: US 2022/0278528 A1
(43) Pub. Date: Sep. 1, 2022

(54) SYSTEM AND METHOD FOR LOCAL EXCHANGE OF ENERGY RESOURCES

(71) Applicant: Foresight Energy Ltd., Hod Hasharon (IL)

(72) Inventors: Evgeny FINKEL, Petah-Tikva (IL); Nir BADT, Tel-Aviv (IL); Yuval FARKASH, Tel-Aviv (IL); Sergei EDELSTEIN, Herzliya (IL); Shmuel ATTALI, Shilo (IL); Emek SADOT, Ram-On (IL)

(21) Appl. No.: 17/682,482

(22) Filed: Feb. 28, 2022

Related U.S. Application Data
(60) Provisional application No. 63/154,939, filed on Mar. 1, 2021.

(51) Int. Cl. H02J 3/32; H02J 3/00; G05B 13/02; G06Q 50/06

(52) U.S. Cl. CPC H02J 3/32; H02J 3/003; H02J 3/004; G05B 13/0265; G06Q 50/06

(57) ABSTRACT

A technique of managing electrical power sharing between consumers connected to a local power grid by determining for each consumer, the amount of electrical power stored in a power storage and the amount of electrical power required for consumption; receiving a retail tariff and an export tariff for electrical power; calculating a total power consumption tariff, based on the total stored and required amount of electrical power; calculating a power sharing tariff based on the received retail tariff, the export tariff, and the total power consumption tariff. Also, determining a consumer to share electrical power based on the calculated power sharing tariff; and allocating energy resources between the consumer and a power storage to maintain balance within the local power grid. Calculation of the power sharing tariff is based on maintaining the total power consumption tariff such that a portion of the electrical power is maintained within the local power grid.

### CROSS-REFERENCE TO RELATED APPLICATION

The present application claims the benefit under 35 U.S.C. § 119(e) of U.S. Provisional Application No. 63/154,939 filed on Mar. 1, 2021, which is herein incorporated by reference in its entirety.

### FIELD OF THE INVENTION

The present invention generally relates to electric power systems. More particularly, the present invention relates to systems and methods for local exchange of energy resources.

### BACKGROUND OF THE INVENTION

In recent years, power consumption data has become available to providers (e.g. power plants) utilizing “smart” power consumption meters. These power consumption meters are usually directly coupled to a consumer, for instance coupled to a power grid of a private household, such that the power provider may at any time retrieve data from the meters, for instance retrieve power consumption data via a communication network.

With technological advancement in renewable energy production, the majority of power grids are coupled to at least some additional power producers (e.g., producing electrical energy from solar power or wind power). While a vast amount of power consumption data is available, there is still a need for a way to manage all of this data to optimize power consumption data and/or power production data in electrical power grids.

### BRIEF SUMMARY

In accordance with certain aspects of the presently disclosed subject matter, there is provided a method of managing electrical power sharing between a plurality of consumers connected to a local power grid. The method comprises: determining for each consumer, the amount of electrical power stored in a power storage; determining for each consumer amount of electrical power required for consumption; receiving a retail tariff and an export tariff for electrical power; calculating a total power consumption tariff, based on the total stored and required amount of electrical power; calculating a power sharing tariff based on the received retail tariff, the export tariff, and the total power consumption tariff; determining at least one consumer to share electrical power based on the calculated power sharing tariff; and allocating energy resources between the determined at least one consumer and at least one power storage in order to maintain balance within the local power grid, wherein the calculation of the power sharing tariff is based on maintaining the total power consumption tariff such that at least a portion of the electrical power maintains within the local power grid.

The method can further comprise training at least one machine learning algorithm based on a dataset of current electrical power consumption for each consumer in the local power grid; and predicting future requirement of electrical power for at least one consumer in the local power grid, using the at least one machine learning algorithm. The prediction of future requirement of electrical power is also based on received weather data.

In accordance with further aspects, maintaining at least a portion of the electrical power within the local power grid causes a reduction in infrastructure requirements.

The method can further comprise receiving for each consumer the amount of electrical power consumed and/or produced for a predefined time period.

In accordance with further aspects, determining at least one consumer to share electrical power comprises allocating power resources to the at least one power storage retrieving power from the power grid, and/or reallocating power resources to a different consumer of the power grid.

In accordance with other aspects of the presently disclosed subject matter, there is provided a system for management of electrical power sharing between a plurality of consumers connected to a local power grid. The system comprises: at least one power storage for each consumer in the local power grid; at least one power consumption meter for each consumer in the local power grid; a tariff database, comprising data for a retail tariff and an export tariff for electrical power. The system further comprises a processor, coupled to the at least one power storage, to the at least one power consumption meter and to the tariff database, wherein the processor is configured to: determine for each consumer, the amount of electrical power stored in a power storage; determine for each consumer amount of electrical power required for consumption; calculate a total power consumption tariff, based on the total stored and required amount of electrical power; calculate a power sharing tariff based on the received retail tariff, the export tariff, and the total power consumption tariff; determine at least one consumer to share electrical power based on the calculated power sharing tariff; and allocate energy resources between the determined at least one consumer and at least one power storage in order to maintain balance within the local power grid. The calculation of the power sharing tariff is based on maintaining the total power consumption tariff such that at least a portion of the electrical power maintains within the local power grid.

In accordance with further aspects, the processor can be configured to allocate power resources to the at least one power storage and/or to consume power from the at least one power storage instead of the power grid.

In accordance with further aspects, the processor can be further configured to: train at least one machine learning algorithm based on a dataset of current electrical power consumption for each consumer in the local power grid; and predict future requirement of electrical power for at least one consumer in the local power grid, using the at least one machine learning algorithm.

In accordance with further aspects, the processor can be further configured to receive for each consumer the amount of electrical power produced for a predefined time period and/or consumed for a predefined time period.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of an exemplary computing device, according to some embodiments of the invention;

FIG. 2 is a block diagram of a power management system for management of electrical power sharing between a plurality of consumers connected to a local power grid, according to some embodiments of the invention; and

FIGS. 3A-3B are flowcharts of a method of managing electrical power sharing between a plurality of consumers connected to a local power grid.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

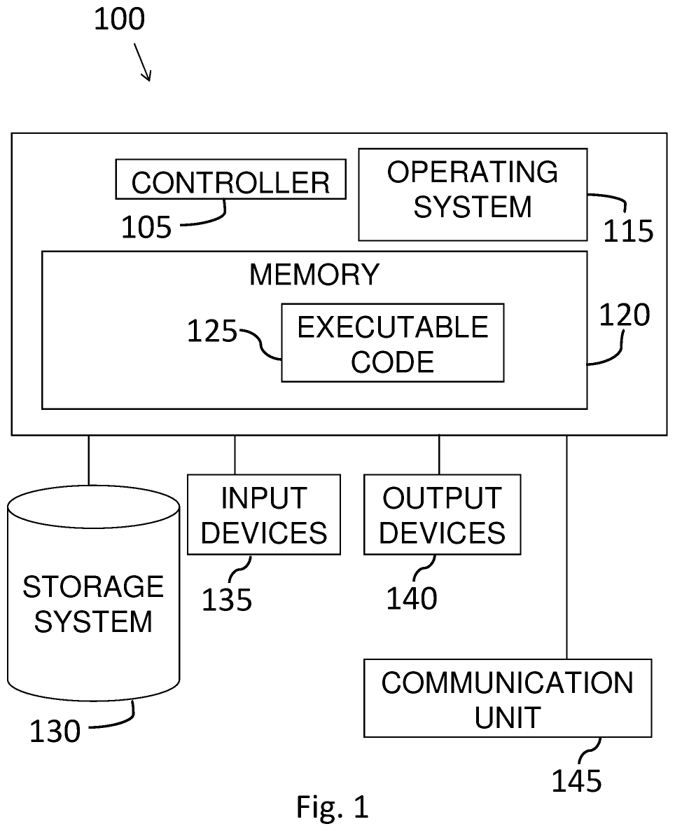

Reference is made to FIG. 1, which is a schematic block diagram of an example of a computing device, according to some embodiments of the invention. Computing device 100 may include a controller or processor 105 (e.g., a central processing unit processor (CPU), a graphics processing unit (GPU), a chip or any suitable computing or computational device), an operating system 115, memory 120, executable code 125, storage 130, input devices 135 (e.g. a keyboard or touchscreen), and output devices 140 (e.g., a display), a communication unit 145 (e.g., a cellular transmitter or modem, a Wi-Fi communication unit, or the like) for communicating with remote devices via a communication network, such as, for example, the Internet. Controller 105 may be configured to execute program code to perform operations described herein. The system described herein may include one or more computing device(s) 100.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPU), GPUs, or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device.

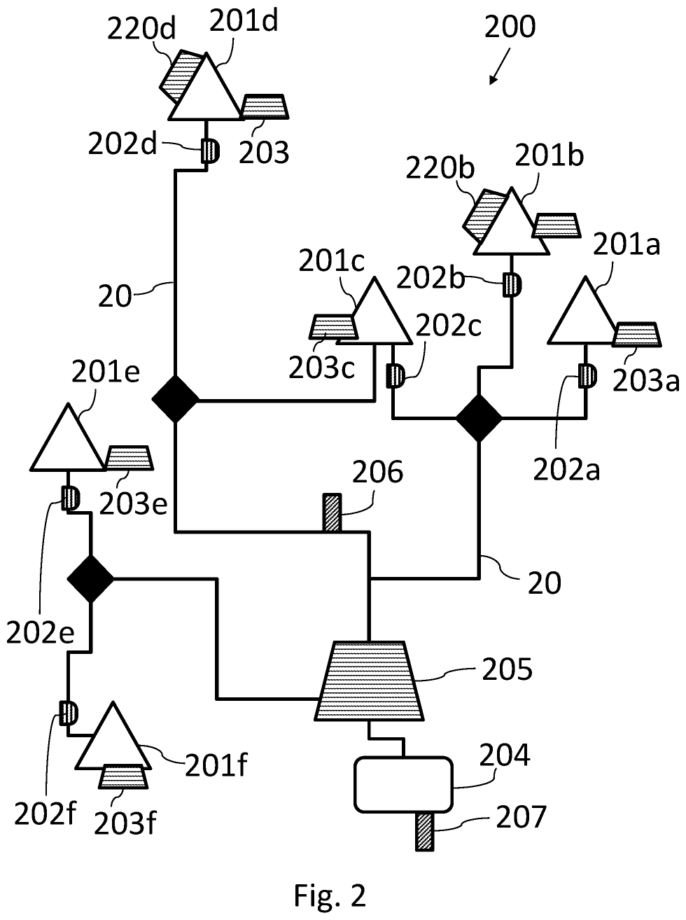

Reference is now made to FIG. 2, which shows a block diagram of a power management system 200 for management of electrical power sharing between a plurality of consumers connected to a local power grid, according to some embodiments.

The power management system 200 may optimize power consumption and/or power production for a (local) power grid 20. The power grid 20 may supply electrical power to a plurality of consumers 201a-f in a local environment, for instance in a village, a neighborhood, a house, etc. It should be noted that each of the consumers 201a-f may also produce electric power (e.g., via solar panels) and not always need to consume power from power plant. In some embodiments, each of the consumers 201a-f may be connected to at least one power consumption meter 202a-f to measure power consumption of that consumer 201a-f.

As is known, each time electric current passes a transformer to a particular consumer 201a-f, energy may be lost (e.g., due to electrical/mechanical losses in the transformer) before reaching the adjacent power plant (or the consumer in the opposite direction). Thus, it may be advantageous to stay local within the power grid 20 and maintain all transfer of power within that power grid 20, while reducing the number of transformers the electric current passes.

In some embodiments, the input data indicative of the consumer's 201a-f power consumption, via the power consumption meter 202a-f, may be received via at least one of the following: programmable logic controller (PLC), smart meter, backup battery gateway, photovoltaic or solar power systems, and Internet of Things (IoT) devices such as a thermostat connected to the internet (e.g., sending consumption data with change of temperature settings).

According to some embodiments, at least one of the consumers 201a-f, connected to the power grid 20, may also be connected to a local power production facility 220 (e.g., a solar panel, a wind turbine, etc.) adapted to produce power from, e.g., renewable energy sources. Such consumers 201a-f with a power production facility 220 may use the produced power for their own power consumption needs, and/or share the produced electrical power within the power grid 20, as further described hereinafter. In some embodiments, power production may be predicted for each consumer 201a-f (e.g., based on known weather data).

In some embodiments, each of the consumers 201a-f may include at least one power storage 203a-f (e.g., a battery) to store electrical power for future use, for instance store power produced by a power production facility 220 for future consumption by the consumer 201a-f (e.g., when the tariff of power consumption from the grid justifies consuming stored power). The power management system 200 may include a first tariff database 204 with data for a retail tariff and/or an export tariff for electrical power in the power grid 20 (e.g., as provided by a local power distributer).

In some embodiments, the power management system 200 may include a processor 205 (e.g., such as controller 105 shown in FIG. 1). The processor 205 may be coupled to the at least one power consumption meter 202a-f, and/or to the at least one power storage 203a-f and/or to the first tariff database 204. The processor 205 may be configured to receive input with various parameters of power usage in the power grid 20 and accordingly determine optimal way to share power within the power management system 200.

The required input may include at least one of: geographical location, number of input devices (e.g., power consumption meters), type of input devices, history of consumption, current tariff (for power consumption and/or production), ambient weather conditions, parameters of power storage (e.g., existing or planned) and type of electrical devices that consume power. Additional input may be provided for parameters of the power grid 20, for instance maximal voltage and/or current allowable in the grid 20 and/or the power storage 203a-f (e.g., maximal capacity of a battery coupled to a solar system). Other inputs may be provided for ambient temperature conditions (e.g., via a dedicated sensor).

In some embodiments, the processor 205 may receive for each consumer 201a-f the amount of electrical power consumed and/or the amount of electrical power produced for a predefined time period.

In some embodiments, the first tariff database 204 and/or the processor 205 may be coupled at least one ambient conditions sensor 206, configured to measure ambient condition in the vicinity of consumers 201a-f For example, the at least one ambient conditions sensor 206 may determine weather conditions for prediction of future consumption and/or production (e.g., affected by ambient temperature, windy weather or by high solar visibility). In some embodiments, the first tariff database 204 and/or the processor 205 may be coupled to at least one second tariff database 207, configured to store tariff changes for different times of day and/or for different dates in a calendar year.

In some embodiments, the processor 205 may be configured to determine for each consumer 201a-f, the amount of electrical power stored in a power storage 203a-f and/or determine for each consumer 201a-f the amount of electrical power required for consumption. Thus, supply and demand of electrical power may be determined for each consumer 201a-f.

In some embodiments, the processor 205 may calculate a total power consumption tariff, based on the total stored and required amount of electrical power. The processor 205 may calculate a power sharing tariff based on the received retail tariff, the export tariff, and the total power consumption tariff. Accordingly, the processor 205 may determine at least one consumer 201a-f to share electrical power of the at least one consumer 201a-f (e.g., with a different consumer) via the power grid 20 based on the calculated power sharing tariff.

In some embodiments, at least one consumer 201a-f in the determined consumers 201a-f may be selected randomly from consumers 201a-f in the system 200 (named herein below local power provider, LPP) that would be suitable to share power with the other consumer 201a-f (named herein after local power receiver, LPR).

According to some embodiments, the processor 205 may issue a command to allocate power resources to the at least one power storage 203a-f (e.g., instead of allocating resources to the power grid 20) as a result of determining the at least one consumer 201a-f (LPP) to share electrical power within the power grid 20. In some embodiments, the processor 205 may issue a command to retrieve power from the power grid 20 (e.g., instead of retrieving resources from the power storage) as a result of determining the at least one consumer 201a-f (LRP) to receive electrical power within the power grid 20. In some embodiments, the processor 205 may issue a command to consume power from the at least one power storage instead of the power grid 20 as a result of determining the at least one consumer 201a-f to receive electrical power within the power grid 20.

In some embodiments, determining at least one consumer 201a-f (LPP) to share electrical power may include reallocation of power resources to a different consumer 201a-f (LRP) of the power grid 20.

In some embodiments, the calculation of the power sharing tariff may be based on maintaining the total power consumption tariff such that at least a portion of the electrical power is consumed within the (local) power grid 20. In some embodiments, the calculation of the power sharing tariff may be based on changes in various tariffs over a time period (e.g. with data received from the at least one second tariff database 207.

In some embodiments, the calculation of the optimized power-sharing tariff may be carried out by at least one machine-learning algorithm. Machine learning algorithms may also be used for forecasting of future consumption needs for each consumer 201a-f. Such an algorithm may receive as input some or all of power consumption needs of the consumers 201a-f in the system 200 and accordingly provide an output with pairs of consumers 201ₙ/201ₘ (LPP/LPR) to share power therebetween.

In some embodiments, the at least one machine learning algorithm may be trained based on a dataset of current electrical power consumption for each consumer 201a-f in the local power grid 20, such that future requirement of electrical power may be predicted for at least one consumer 201a-f, using the at least one machine learning algorithm.

According to some embodiments, power loss may be reduced by maintaining more power exchange within the local power grid 20, since less energy passes through transformer. Additionally, the required infrastructure for the power grid 20 may be reduced if more of power consumptions needs are maintained within the local power grid 20, such that there is no longer a need for external infrastructure.

According to some embodiments, each consumer 201a-f sharing power in the power grid 20 (LPP), using the system 200, may benefit from better tariffs due to the exchange.

For example, electrical power may be shared in a local power grid between a first consumer that produces power and a second consumer that consumes power. In that local power grid, a distribution system operator (DSO) may manage power distribution between the local power grid and a corresponding electrical power facility (e.g., a power plant). The first consumer may produce electrical power 10 kWh (e.g., with a wind turbine, solar panel, etc.) and store the produced energy in a power storage. The first consumer may offer to sell the produced power to the DSO at a price of 0.2$ per kWh. The second consumer may require 20 kWh from the local power grid (e.g., required to power electrical appliances of the second consumer). Thus, the second consumer may pay the DSO 10$ for the purchase of 20 kWh at a price of 0.5$ per kWh. It should be noted that the DSO only manages the distribution of power and needs to get the power supply from the electrical power facility, for instance at a price of 9.6$ for 10 kWh required for the second consumer in addition to the 10 kWh produced by the first consumer. The DSO may pay 2.5$ to the first consumer for the produced electrical power, such that the DSO may distribute the power between the first consumer, second consumer and the electrical power facility. Accordingly, consumers of the local power grid may receive better price rates for the distribution of electrical power if the exchanged power is maintained within the local grid (without the need of passing through additional transformers).

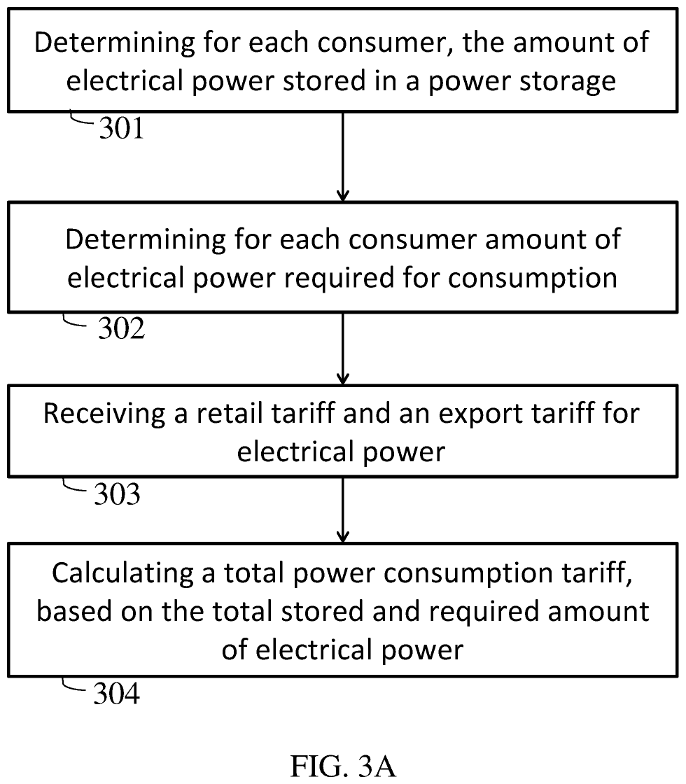

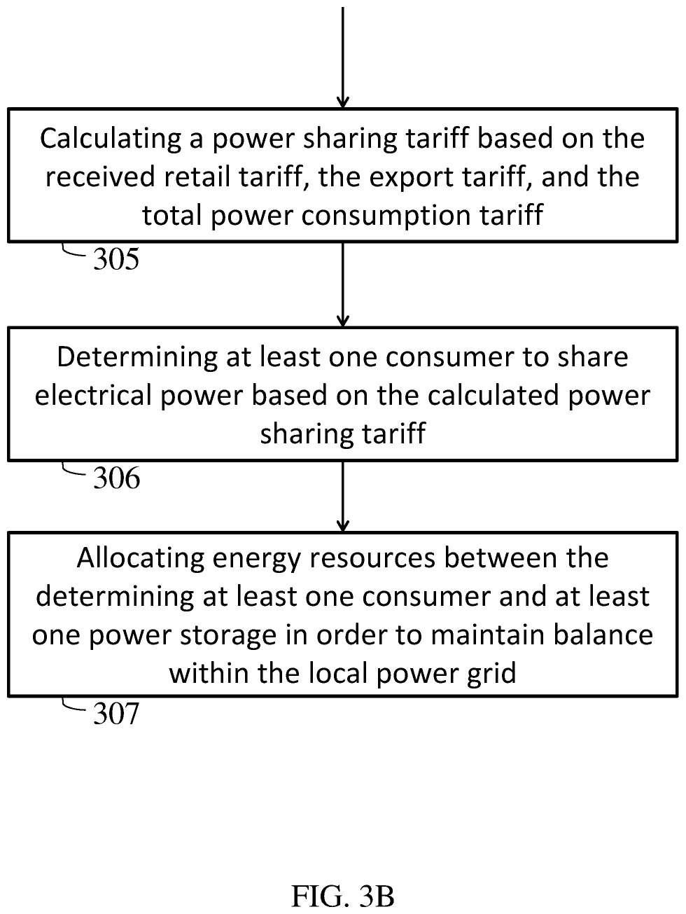

Reference is now made to FIGS. 3A-3B, which show a flowchart of a method of managing electrical power sharing between a plurality of consumers connected to a local power grid, according to some embodiments.

In Step 301, the amount of electrical power stored in a power storage may be determined for each consumer. In Step 302, the amount of electrical power required for consumption may be determined for each consumer.

In Step 303, a retail tariff and an export tariff for electrical power may be received (e.g., at the processor 205 shown in FIG. 2). In Step 304, a total power consumption tariff may be calculated, based on the total stored and required amount of electrical power. In Step 305 a power sharing tariff may be calculated based on the received retail tariff, the export tariff, and the total power consumption tariff.

In Step 306, at least one consumer may be determined (e.g., at the processor) to share electrical power based on the calculated power sharing tariff In some embodiments, the calculation of the power sharing tariff may be based on maintaining the total power consumption tariff such that at least a portion of the electrical power maintains within the local power grid. In Step 307, energy resources may be allocated between the determining at least one consumer and at least one power storage in order to maintain balance within the local power grid. For example, the system may automatically allocate electrical power to be stored in the at least one power storage. In another example, the system may automatically allocate electrical power from the at least one power storage to be consumed by the determining at least one consumer.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of managing electrical power sharing between a plurality of consumers connected to a local power grid, the method comprising:
determining for each consumer, an amount of electrical power stored in a power storage;
determining for each consumer an amount of electrical power required for consumption;
receiving a retail tariff and an export tariff for electrical power;
calculating a total power consumption tariff, based on the total stored and required amount of electrical power;
calculating a power sharing tariff based on the received retail tariff, the export tariff, and the total power consumption tariff;
determining at least one consumer to share electrical power based on the calculated power sharing tariff; and
allocating energy resources between the determined at least one consumer and at least one power storage in order to maintain balance within the local power grid,
wherein the calculation of the power sharing tariff is based on maintaining the total power consumption tariff such that at least a portion of the electrical power is maintained within the local power grid.

2. The method of claim 1, further comprising:
training at least one machine learning algorithm based on a dataset of current electrical power consumption for each consumer in the local power grid; and
predicting a future requirement of electrical power for at least one consumer in the local power grid, using the at least one machine learning algorithm.

3. The method of claim 2, wherein the prediction of the future requirement of electrical power is also based on received weather data.

4. The method of claim 2, further comprising predicting power production for each consumer.

5. The method of claim 1, wherein maintaining at least a portion of the electrical power within the local power grid causes a reduction in infrastructure requirements.

6. The method of claim 1, further comprising receiving for each consumer an amount of electrical power consumed for a predefined time period.

7. The method of claim 1, further comprising receiving for each consumer an amount of electrical power produced for a predefined time period.

8. The method of claim 1, wherein determining at least one consumer to share electrical power comprises allocating power resources to the at least one power storage.

9. The method of claim 1, wherein determining at least one consumer to share electrical power comprises retrieving power from the power grid.

10. The method of claim 1, wherein determining at least one consumer to share electrical power comprises consuming power from the at least one power storage instead of the power grid.

11. The method of claim 1, wherein determining at least one consumer to share electrical power comprises reallocating power resources to a different consumer of the power grid.

12. A system for management of electrical power sharing between a plurality of consumers connected to a local power grid, the system comprising:
at least one power storage for each consumer in the local power grid;
at least one power consumption meter for each consumer in the local power grid;
a tariff database, comprising data for a retail tariff and an export tariff for electrical power; and
a processor, coupled to the at least one power storage, to the at least one power consumption meter, and to the tariff database, wherein the processor is configured to:
determine for each consumer, an amount of electrical power stored in a power storage;
determine for each consumer an amount of electrical power required for consumption;
calculate a total power consumption tariff, based on the total stored and required amount of electrical power;
calculate a power sharing tariff based on the received retail tariff, the export tariff, and the total power consumption tariff;
determine at least one consumer to share electrical power based on the calculated power sharing tariff; and
allocate energy resources between the determined at least one consumer and at least one power storage in order to maintain balance within the local power grid,
wherein the calculation of the power sharing tariff is based on maintaining the total power consumption tariff such that at least a portion of the electrical power is maintained within the local power grid.

13. The system of claim 12, wherein the processor is further configured to allocate power resources to the at least one power storage.

14. The system of claim 12, wherein the processor is further configured to retrieve power from the power grid.

15. The system of claim 12, wherein the processor is further configured to consume power from the at least one power storage instead of the power grid.

16. The system of claim 12, wherein the processor is further configured to reallocate power resources to a different consumer of the power grid.

17. The system of claim 12, wherein the processor is further configured to:
train at least one machine learning algorithm based on a dataset of current electrical power consumption for each consumer in the local power grid; and
predict a future requirement of electrical power for at least one consumer in the local power grid, using the at least one machine learning algorithm.

18. The system of claim 12, wherein the processor is further configured to receive for each consumer an amount of electrical power produced for a predefined time period.

19. The system of claim 12, wherein the processor is further configured to receive for each consumer an amount of electrical power consumed for a predefined time period.

20. The system of claim 12, wherein maintaining at least a portion of the electrical power within the local power grid causes a reduction in infrastructure requirements.
